(19) United States
(12) Patent Application Publication
(10) Pub. No.: US 2010/0134809 A1
(43) Pub. Date: Jun. 3, 2010

(54) GAMMA CORRECTION METHOD FOR ERROR DIFFUSION

(75) Inventor: Ching-Wei CHANG, Vancouver, WA (US)

Correspondence Address: Stolowitz Ford Cowger LLP/Sharp, 621 SW Morrison St, Suite 600, Portland, OR, 97205, US

(73) Assignee: Sharp Laboratories of America, Inc., Camas, WA (US)

(21) Appl. No.: 12/327,380

(22) Filed: Dec. 3, 2008

(51) Int. Cl. H04N 1/60

(52) U.S. Cl. 358/1.9

(57) ABSTRACT

An image processing system includes a printing device having a printing resolution, and a processor. The processor is configured to receive input image data comprising an input tone, and to dither the input image data at a halftone resolution, wherein the halftone resolution is less than the printing resolution of the printing device. The processor is further configured to perform multi-thresholding of the image data to identify a multi-pixel output tone level, and to generate output image data comprising the multi-pixel output tone level. The output image data is printed at the printing resolution. The multi-thresholding of the image data may further include an error diffusion algorithm providing gamma correction of the input tone.

### TECHNICAL FIELD

The invention relates to an improved method of error diffusion for image reproduction on a printed media.

### BACKGROUND

In reproducing color or monochrome images, conventional printers are typically able to reproduce an input color or tone as one of a finite number of output tone levels. The number of colors that may be generated and displayed on a conventional monitor are typically many more times that of the number of output tone levels which a printer is able to print.

A collection of unit halftone cells are printed by the printer to create a printed image which appears similar to the input image appearing on the monitor. The halftone cell allows the printer to render more levels of colorant level than a physical print head can otherwise handle, on a per pixel basis. The halftone cell can be described as a matrix containing “n by m” pixels, which collectively can represent a full range of output tone level. For an eight-bit representation of color or grey scale, a full range includes 255 levels. For a two-dimensional halftone cell, the matrix may include 16 by 16 bitonal pixels to reproduce all 255 levels.

In a conventional binary halftone cell as illustrated in FIG. 1, halftone dot growth is achieved by adding more inked pixels in the two-dimensional matrix. For example, a tone level of 25 may be represented by adding 25 pixels to matrix 1A; a tone level of 34 may be represented by adding 34 pixels to matrix 1B; a tone level of 64 may be represented by adding 64 pixels to matrix 1C; and a tone level of 126 may be represented by adding 126 pixels to matrix 1D. Adding all 255 pixels of any of these matrices represents the maximum tone, or 100% full tone value.

In practice, the actual tone level or grey level achieved may vary according to dot gain or dot growth during different stages of the halftone cell generation, resulting in a non-linear relationship between output tone level and the measured tone level. FIG. 2 illustrates an example of a tone reproduction curve 3 (TRC) including the non-linear relationship. Because of dot gain, a tone level including 32 inked pixels may in fact correspond with a measured tone level of 64. Whereas a tone level including 64 inked pixels may correspond with a tone level of 126. 128 inked pixels is shown as corresponding to a tone level of 204; 224 inked pixels corresponds to a tone level of 251; and 255 inked pixels corresponds to a maximum tone level of 255.

Gamma correction is typically used during the halftoning process to account for the expected variation in measured tone level due to dot gain. Gamma correction may be accomplished by taking an inverse curve of the tone reproduction curve 3 to form a corresponding lookup table. Accordingly, if a tone level of 204 is desired, 128 inked pixels will be selected rather than 204 inked pixels. Because of the non-linear relationship of the tone reproduction curve 3, however, applying gamma correction results in a significant reduction of available output tone levels.

For example, whereas the output tone levels illustrated as values 32 to 64 comprise 33 different requested tone levels, this range of output tone levels corresponds to tone levels from 64 to 126, or 63 different tone levels. Accordingly, at least 30 (i.e. 63−33) of the tone levels will not match to any of the output tone levels, since there is a one-to-one relationship between each of the output tone levels and the input tone levels. Whereas the output tone levels illustrated as 224 to 255 comprise 12 different requested tone levels, this range of output tone levels corresponds to tone levels from 251 to 255, or 5 different tone levels. Accordingly, at least 7 (i.e. 12−5) of the output tone levels will not match to any of the input tone levels.

Conventional gamma correction adjusts the input pixel tone value based on constant-patch dot gain measurements that cannot predict the variety of connection patterns among neighboring pixels, or neighboring dots where there are not constant tone patches such as in a photograph. Predetermined tone mappings of conventional gamma correction cannot accurately produce a desired tone level after a spatially varying dot gain effect of error diffusion is added. Accordingly, different halftone processes require different gamma correction curves.

Whereas conventional gamma correction is applied to the entire halftone dot, each pixel of the halftone dot is further processed by error diffusion to improve the reproduction of continuous tone (contone) shading. Error diffusion is applied on a pixel-by-pixel basis, and results in frequency modulated dithering. Due to the variability of error diffusion and its effect on proximity and number of pixels that are ultimately inked, this causes further variation in the measured tone level than what was expected based on gamma correction. The additional variation of measured tone level results in further loss of tone reproduction accuracy.

### BRIEF DESCRIPTION OF THE DRAWINGS

FIG. 1 illustrates conventional binary halftone matrices comprising different numbers of pixels.

FIG. 2 illustrates an example of a tone reproduction curve including a non-linear relationship between input tone level and measured output tone level.

FIG. 3 illustrates an example image reproduction system comprising a processor and a printing device.

FIG. 4 illustrates an example embodiment of multi-threshold halftone process.

FIG. 5 illustrates upscaling an input tone level to a full-scale halftone matrix.

FIG. 6 illustrates upscaling an input tone level to a reduced scale halftone matrix.

FIG. 7 illustrates upscaling a pixel region of the reduced scale halftone matrix of FIG. 6 to a full scale output tone comprising multiple pixels.

FIG. 8 illustrates different levels of full scale output tone comprising multiple pixels.

FIG. 9 illustrates an example halftone operation comprising a multi-thresholding algorithm.

FIG. 10 illustrates an example operation of multi-threshold halftone processing.

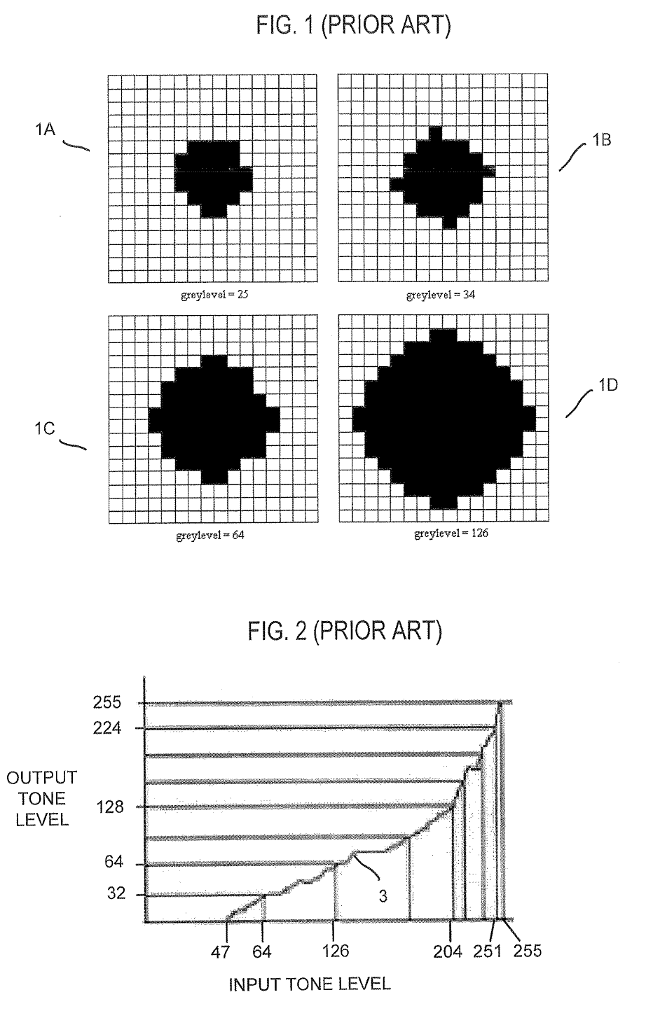

### SUMMARY OF THE INVENTION

An image processing system is herein disclosed as comprising a printing device having a printing resolution, and a processor. The processor is configured to receive input image data comprising an input tone, and to dither the input image data at a halftone resolution, wherein the halftone resolution is less than the maximum printing resolution of the printing device. The processor is further configured to perform multi-thresholding of the image data to identify a multi-pixel output tone level, and to generate output image data comprising the multi-pixel output tone level. The output image data is printed at the printing resolution. The multi-thresholding of the image data may further include, or be combined with, an error diffusion algorithm providing gamma correction of the input tone.

A method of image reproduction is herein disclosed. The method comprises receiving input image data comprising an input tone, and scaling the input image data at a halftone resolution, wherein the halftone resolution is one half the printing resolution of a printing device. Multi-thresholding of the scaled image data is performed to identify a multi-pixel output tone level corresponding with the input tone, and output image data is generated, wherein the output image data comprises the multi-pixel output tone level. The method further comprises printing the output image data, wherein the output image data is printed at the printing resolution of the printing device.

A computer-readable medium having instructions stored thereon, is disclosed herein. When the instructions are executed by at least one device, the instructions are operable to receive input image data comprising an input tone. The input image data is rendered to a halftone resolution, wherein the halftone resolution is less than a printing resolution. The instructions are further operable to perform multi-thresholding of the image data to identify a multi-pixel output tone level, and to generate output image data comprising the multi-pixel output tone level. The output image data is printed at the printing resolution.

The invention will become more readily apparent from the following detailed description of a preferred embodiment of the invention which proceeds with reference to the accompanying drawings.

### DESCRIPTION OF EXAMPLE EMBODIMENTS

Images which are displayed on computer monitors or otherwise projected for human perception may be defined by a first color space. Monitors provide an exceptionally large range of hue, saturation and intensity of the colors displayed. For example, it is not uncommon for monitors to have the capability of providing 32 bits worth of color data. Color space models for projected images typically include tuples of numbers, such as red, green and blue, otherwise known as the RGB color space. In the RGB color space, red, green and blue are often each represented by an 8 bit range of color variation.

Graphic devices such as printers, on the other hand, typically include but 3 or 4 bits worth of color variation. Although color space models for printers may also include tuples of numbers, and in some cases the addition of black, each of the tuples are limited to bitonal representation of 1 bit. That is, either on or off. Printed images are often defined by a cyan, magenta and yellow (CMY) color space. Some printers include a separate toner for black (K), in which case the images may be defined by a CMYK color space.

Input images are processed according to a rendering pipeline. The rendering pipeline may comprise color conversion, color separation, scaling, and halftoning.

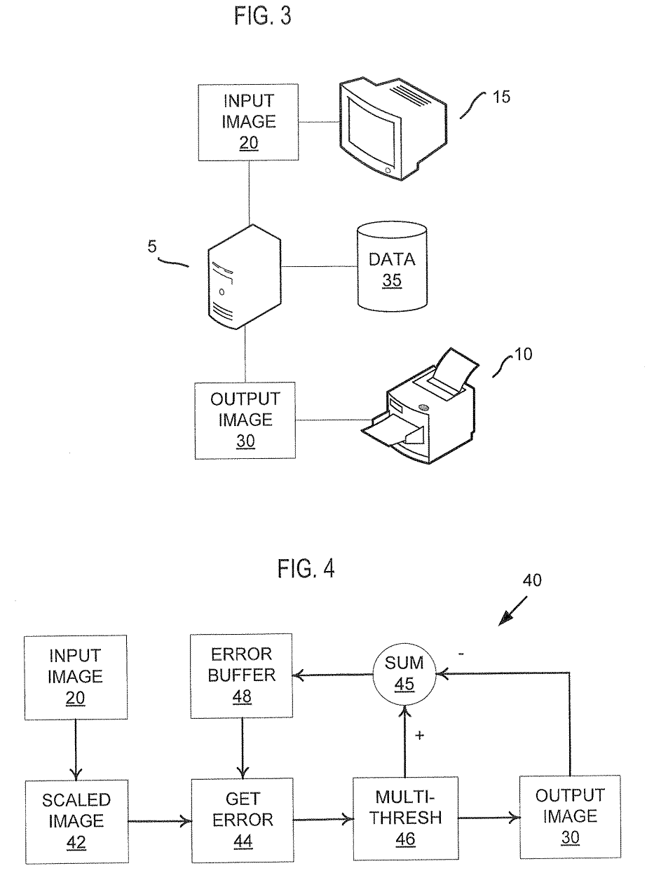

FIG. 3 illustrates an example image reproduction system comprising a processor 5 and a printing device 10. The input image 20 may be displayed on an imaging device 15. The imaging device 15 may include any conventional device used to display or capture an image, such as a camera, scanner, or monitor. The printing device 10 may include any device capable of printing an image on a printed media. A processor 5 may be configured to operate one or both of the imaging device 15 and the printing device 10. In one embodiment, the processor 5 is provided as part of the printing device 10.

The printing device 10 may be configured to print a halftone dot using bi-tonal or multi-tone levels. The halftone dot comprises a plurality of pixels, wherein each pixel is associated with a corresponding tone level. The processor 5 may be configured to receive a request to print a bitmap comprised of one or more colors. For example, the input image 20 may comprise a plurality of colors. A grey level may then be determined for each of the one or more colors. The processor 5 may further be configured to associate one of the tone levels of the printing device 10 with the identified grey level of the input image 20. A halftone matrix may be selected from a plurality of halftone matrices in database 35 for the associated tone level.

The processor 5 compares the identified tone level or grey level with a plurality of pixel threshold values of the selected halftone matrix to determine the corresponding tone level of each of the plurality of pixels. The comparison may be performed using bitonal halftone thresholding and multi-thresholding techniques as described further herein. Each of the colors of the input image 20 may be separately processed by the processor 5 in generating one or more halftone dots of the output image 30. Accordingly, a corresponding tone level for the plurality of pixels may be determined separately for each of the one or more colors. In one embodiment, separate halftone dots are generated for each of the one or more colors, and the printing device 10 is configured to combine the separate halftone dots to generate the output image 30.

The printing device may be understood as having a printing resolution. For example, the printing resolution may be 600 dots per inch (dpi), 1200 dpi, or any other resolution known to one skilled in the art. The printing device may further have a maximum printing resolution, wherein the printer may be configured to print using the maximum printing resolution, or some printing resolution which is less than the maximum printing resolution. The processor 5 may be configured to receive the input image data 20 comprising an input tone. The input image data 20 may be associated with a resolution of the imaging device 15. In one embodiment, the resolution of the imaging device 15 is less than the printing resolution of the printing device 10. For example, the resolution of the imaging device may be 200 dpi or 400 dpi.

The processor may be further configured to render, dither, or scale the input image data 20 to a second resolution greater than the resolution of the imaging device 15. The input image data 20 may further be rendered, dithered, or scaled to a resolution which is less than or equal to that of the imaging device 15. In one embodiment, the second resolution is less than the printing resolution of the printing device 10. Where the printing device 10 prints the output image 30 using halftone dots, a number of printed pixels may be used to represent any one pixel associated with the input image. Where the resolution of the printing device 10 is greater than the resolution of the imaging device 15, this allows for the output image 30 to be visually displayed with a similar resolution as the input image 20, wherein a number of printed pixels are used to reproduce the tone level of the input image 20.

By upscaling the input image 20 to the second resolution, the processor 5 may perform multi-thresholding of the scaled image data to identify a multi-pixel output tone level. Since the second resolution may be less than the printing resolution of the printing device 10, the tone level of the input image 20 may be modeled using the multi-tone output tone level of the output image 30. The multi-pixel output tone level may comprise an array or group of pixels which is a subset of a printed halftone dot of the output image 30.

The multi-tone output level may be stored in a lookup table or database 35. The database 35 may store a plurality of multi-pixel output tone levels, wherein each of the plurality of multi-pixel output tone levels corresponds to a different grey level or tone level. The different grey levels or tone levels may be measured tone level values as determined from a printed halftone dot or partial halftone dot.

The processor 5 may generate the output image data 30 comprising the multi-pixel output tone level. Output image data 30 may comprise a plurality of printed halftone dotes, each printed halftone dot comprised of a plurality of pixel arrays, and wherein each pixel array is associated with a multi-pixel output tone level. The printing device 10 may then print the output image 30, wherein the output image is printed at the printing resolution of the printing device 10. The printing device 10 may be configured to print the output image 30 at the maximum printing resolution.

FIG. 4 illustrates an example embodiment of multi-threshold halftone process 40. As previously discussed, the input image 20 may be scaled or upscaled. The input image 20 may be scaled to a resolution that is less than a printing resolution of the printing device 10 (FIG. 3) to produce scaled image 42. In one embodiment, the scaled resolution is one half the printing resolution of the printing device 10. The scaled, or halftone resolution may also be configured as one third, one fourth, or some other fraction of the printing resolution for certain embodiments.

The scaled image 42 is modified by any error value retrieved from error buffer 48. The error value may be associated with a prior input image that underwent the multi-threshold halftone process 40. The modified, scaled image of operation 44 then undergoes multi-thresholding 46 to identify an associated multi-pixel output tone level. The multi-thresholding 46 involves a comparison of the modified tone level 44 with one or more threshold tone values. In one embodiment, the modified tone level 44 is compared with four different threshold tone values.

One of the multi-pixel output tone levels is selected for output image 30. The output image 30 may comprise an array of pixels, for example, wherein the array of pixels is a subset of a printed output halftone dot. A new halftone error 45 may be determined as the difference between the modified tone level 44 and the selected multi-pixel tone level from the multi-thresholding 46. The new halftone error 45 may be saved in the error buffer 48 to modify a subsequent received image data and corresponding input tone.

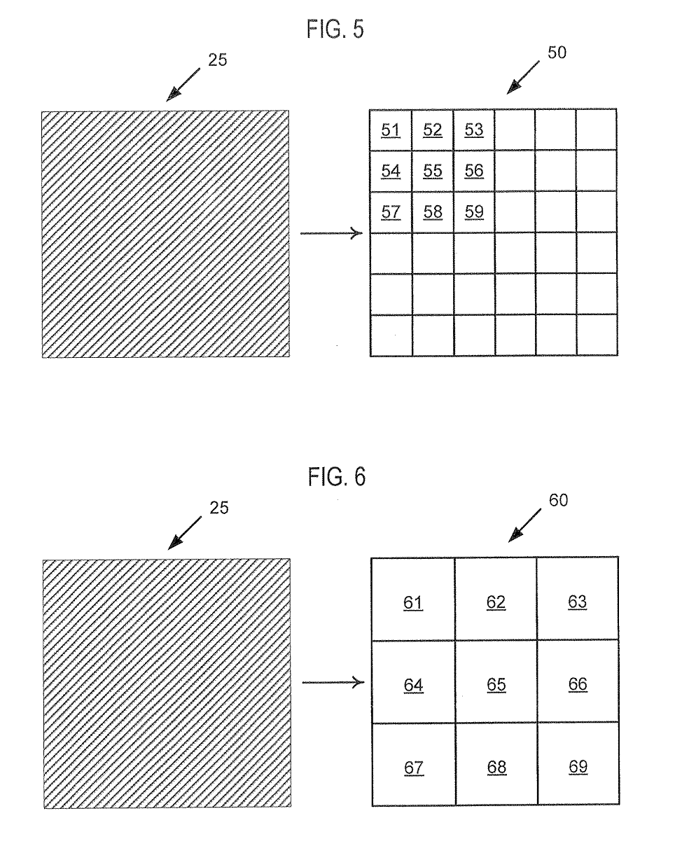

FIG. 5 illustrates upscaling an input tone level 25 to a full-scale halftone matrix 50. The input tone level 25 may be associated with a first resolution of the imaging device 15 (FIG. 3), whereas the full-scale halftone matrix 50 may be associated with a printing resolution of the printing device 10. The input tone level 15 is illustrated as being formed by a single contone pixel, whereas the full-scale halftone matrix 50 is illustrated as being comprised of a six-by-six array of pixels. In conventional halftone processing, a gamma correction is applied to the input tone level 25 to determine a pixel pattern (or number of pixels to be printed) for the full-scale halftone matrix 50. Each pixel of the full-scale halftone matrix 50 may be understood to have an associated threshold value that is compared to the input tone level 25 in determining which of the pixels will be printed.

During the halftone process, error diffusion is applied to each pixel in the full-scale halftone matrix 50 in order to replicate the input tone level 25. Accordingly, whether or not any of the pixels 51-59 are printed will depend in part on whether their neighboring pixels are printed. As error diffusion is applied for all pixels in the full-scale halftone matrix 50, this may cause the original pixel pattern determined by gamma correction to vary. For example, if pixel 55 is not printed, an error value may be carried to one or more of the neighboring pixels 51-54 and 56-59. Error diffusion is applied to all of the 36 pixels comprising the full-scale halftone matrix 50 during the halftone process. As a result, the tone value associated with full-scale halftone matrix 50 may not match the input tone level 25 after the halftone process has been completed, in part due to dot gain from the modified halftone matrix pattern.

FIG. 6 illustrates upscaling the input tone level 25 to a reduced scale halftone matrix 60. The reduced scale halftone matrix 60 is illustrated as comprising a three-by-three array of pixel regions 61-69. In one embodiment, the reduced scale halftone matrix 60 is associated with a lower resolution than the maximum resolution of the printing device 10 (FIG. 3). The reduced scale halftone matrix 60 may be associated with a resolution that is one half the printing resolution of the printing device 10. The reduced scale halftone matrix 60 may be generated without applying a gamma correction curve to the input tone level 25. Additionally, by dithering the input image at a reduced resolution, a computation time of the halftoning and error diffusion process is reduced. Tone levels for a smaller number of pixel regions, as compared to total number of pixels, are processed for the input tone level 25.

By way of example, an input image may be associated with an imaging device such as a camera having an image resolution of 200 dpi. The printing device may have a printing resolution of 1200 dpi. In one embodiment, the printing resolution of 1200 dpi is the maximum printing resolution of the printing device. Where the input image is upscaled to one half resolution of the printing device, it would be upscaled or dithered to 600 dpi before the halftoning process is initiated. Rendering at different resolutions may not be noticable to the human eye, particularly when the output image is printed at full or maximum resolution.

Each pixel region of the reduced scale halftone matrix 60 may be understood to have one or more associated threshold values that are compared to the input tone level 25 in determining an output tone level for each of the pixel regions. During the halftone process, error diffusion is applied to each pixel region in the reduced scale halftone matrix 60, in order to replicate the input tone level 25. Instead of comparing the input tone level 25 with a single threshold value, each of the pixel regions 61-69 may be associated with a plurality of threshold values. Each threshold value is associated with a different tone level. Accordingly, each of the pixel regions 61-69 may be associated with a plurality of different tone levels. A tone level selected for neighboring pixel regions may affect the error diffusion applied to pixel regions 61-69.

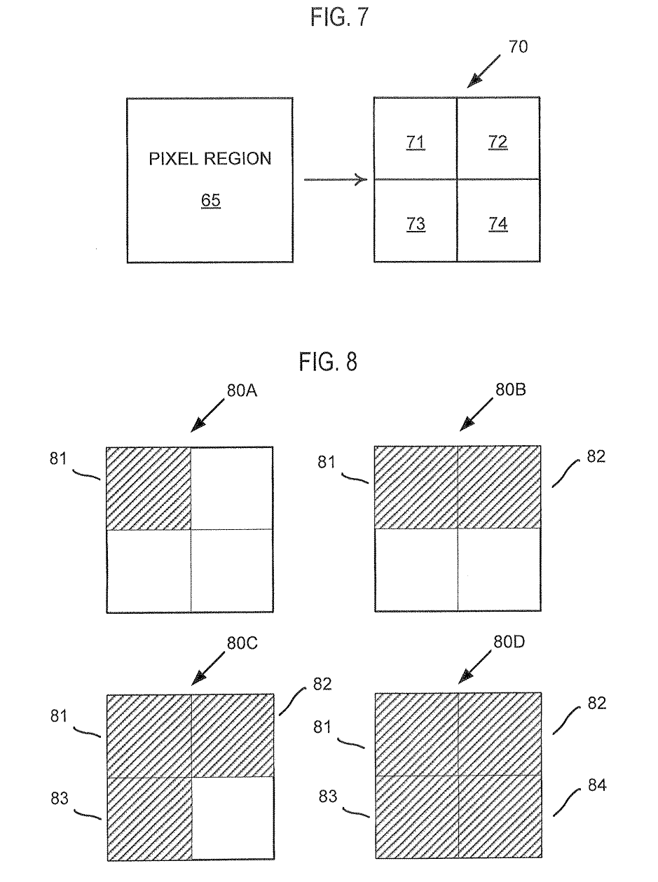

FIG. 7 illustrates upscaling the pixel region 65 of the reduced scale halftone matrix of FIG. 6 to a full scale output tone 70 comprising multiple pixels 71-74. Whereas error diffusion may operate on the pixel region 65, the multiple pixels 71-74 are not operated on directly by error diffusion. Rather, according to the result of the multi-thresholding, as modified by error diffusion, a different multi-pixel tone value may be selected to represent the pixel region 65. Any of pixels 71-74 may be enabled or printed according to the desired tone level for pixel region 65. If none of the pixels 71-74 are enabled or printed, then the tone level for pixel region 65 matches to paper white, or zero tone.

By representing the pixel region 65 as multiple pixels 71-75, the resolution of the reduced scale halftone matrix of FIG. 6 may be restored to the full or maximum resolution of the printing device 10 (FIG. 3). In one embodiment, the multi-pixel output tone level associated with the pixel region 65 comprises an array having a maximum of four printed pixels. By converting or associating the pixel region 65 with multiple pixels, the pixel region 65 provides multi-tonal output using a bi-tonal printer. In other embodiments, the pixel region 65 may comprise a different number or array of pixels. For example, the pixel region may comprise nine or sixteen pixels for a three-by-three or four-by-four array, respectively.

FIG. 8 illustrates different levels 80A, 80B, 80C, 80D of full scale output tone comprising multiple pixels. A first output tone level 80A for a pixel region is illustrated as comprising a single enabled or printed pixel 81. Where the pixel region is shown as comprising a two-by-two pixel array or matrix, one out of four available pixels represent a theoretical 25% tone level. However, due to dot gain, the actual measured tone value of the printed output image corresponding to the first output tone level 80A may be greater, for example 40% of maximum tone level. A second output tone level 80B for the pixel region is illustrated as comprising two enabled or printed pixels 81, 82. Two out of four available pixels represent a theoretical 50% tone level. The actual measured tone value of the printed output image corresponding to the second output tone level 80B may be greater, for example 80% of maximum tone level.

A third output tone level 80C for the pixel region is illustrated as comprising three enabled or printed pixels 81, 82, 83. Three out of four available pixels represent a theoretical 75% tone level. The actual measured tone value of the printed output image corresponding to the third output tone level 80C may be greater, for example 92% of maximum tone level. A fourth output tone level 80D for the pixel region is illustrated as comprising four enabled or printed pixels 81, 82, 83, 84. When all four pixels are printed, the actual measured tone value of the printed output image corresponding to the fourth output tone level 80D may be understood as equaling the maximum tone level.

Both the number of enabled or printed pixels 81-84 and the measured tone value associated with the one or more pixel regions may be stored in a lookup table or database, such as database 35 of FIG. 3. The number of measured tone values stored in the database 35 may vary depending on the number of pixels associated with the pixel region, as well as the number of bits used to represent tone level for each pixel in the case of multi-tone printer. For example, the number of measured tone values may equal every combination of enabled and disabled pixels within the pixel region. The number of measured tone values may further include every combination of tone level per pixel, for a multi-tone printer.

By storing the measured tone values for the pixel regions, gamma correction of the input tone may be accomplished as part of the multi-thresholding process, rather than being performed prior to error diffusion. The placement and number of pixels which are enabled within the pixel region may therefore be controlled or known during the halftone process. Individual pixels within the pixel region (e.g. pixel 81) are not affected by error diffusion of other individual pixels 82-84 within the pixel region, since error diffusion may instead be applied to the entire pixel region (e.g. pixel region 65 of FIG. 7). The multi-thresholding associated with pixel regions also allow for control of pixel patterns in neighboring dots, and hence an ability to control dot gain as between pixels located in adjacent dots.

Whereas conventional gamma correction curves modify the entire halftone dot of the output image with that of the input tone level, the multi-thresholding technique provides a tone adjustment for each of the pixel regions that comprise the halftone dot. Accordingly, the gamma correction of the input tone may be performed as part of the error diffusion process. The need for performing the initial processing step of applying the conventional gamma correction curve before halftoning is avoided. This reduces overall processing time of the input tone and generation of the corresponding output tone. In addition, only one fourth the number of error diffusion calculations may be used for pixel regions comprised of four pixels, as compared to if each pixel were to be separately processed. Further reductions in error diffusion calculation may be obtained where the pixel regions comprise a larger number of pixels (e.g. nine, sixteen, twenty five, or more). The reduction in the number of error diffusion calculations may vary according to the number of pixels associated with the pixel region, or according to the number of different tones that may be associated for each pixel in the pixel region if a multi-tone printer is used.

By controlling the placement of individual pixels and their neighboring pixels within the pixel region, an amount of dot gain in the output image can be controlled, measured, and accounted for. This provides for an improved replication of the input image and it associated tone level. The multi-thresholding may be performed for any input tone level, and allows the input tone level and the output tone level to be related on a one-to-one relationship, so that every input tone level (e.g. 255 levels) may be represented by an equal number of output tone levels. By performing error diffusion on the pixel regions, instead of each individual pixel separately, the output tone level may be printed more reliably by limiting or controlling the amount of dot gain that might otherwise occur from a variability of pixel placement and pixel concentration that occurs as a result of conventional error diffusion.

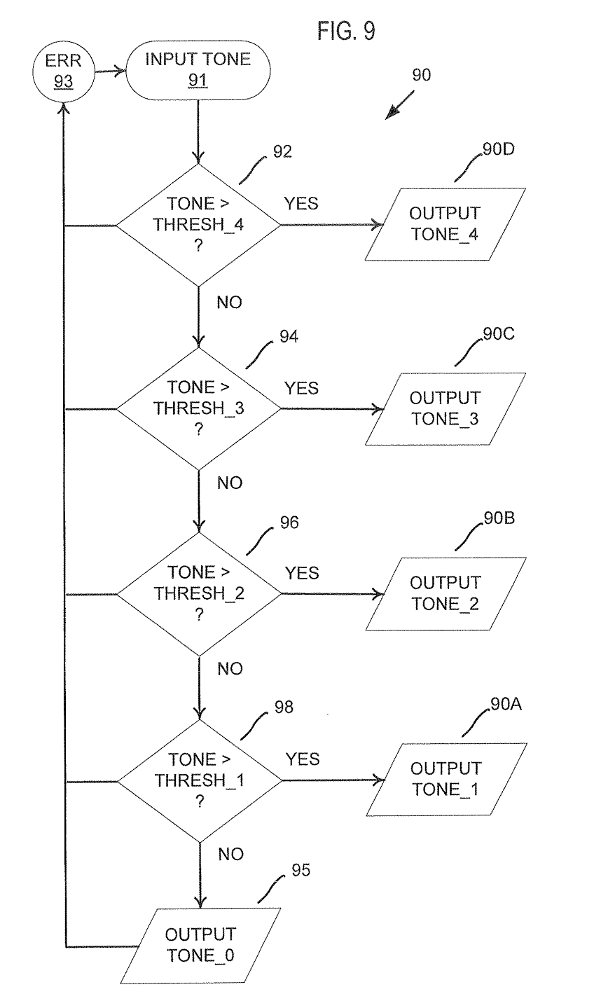

FIG. 9 illustrates an example halftone operation 90 comprising a multi-thresholding algorithm. An input tone 91 may be modified with an error value for a current position, for example, as affected by one or more neighboring pixels or pixel regions. The error value may be stored in an error buffer 93. The input tone 91 may be scaled, or upscaled, from an imaging device resolution to a printing device resolution. In one embodiment, the input tone 91 is upscaled to a resolution that is less than the printing resolution of the printing device.

The input tone 91 is compared to a multi-threshold value THRESH_4 at operation 92. The multi-threshold value THRESH_4 may be associated with a maximum tone level. If the input tone 91 is greater than the multi-threshold value THRESH_4, then an output tone 90D is selected. In one embodiment, the output tone 90D comprises a maximum tone level. Where the output tone 90D is represented by a two-by-two pixel array, it may be understood to correspond to the fourth output tone level 80D of FIG. 8, comprising four enabled or printed pixels. When the output tone 90D is selected, an error value is sent to error buffer 93. The error value may be calculated as the difference between the input tone 91 and the density or tone level of output tone 90D. Where tone level is represented by an 8-bit data value, the density level of the output tone 90D may be understood to be 255, or a maximum tone level.

If the input tone 91 is less than the multi-threshold value THRESH_4, then the input tone 91 is next compared to a multi-threshold value THRESH_3 at operation 94. The multi-threshold value THRESH_3 may be associated with a reduced tone level that is less than output tone 90D. If the input tone 91 is greater than the multi-threshold value THRESH_3, then an output tone 90C is selected. In one embodiment, the output tone 90C comprises a reduced tone level that is less than the maximum tone level. Where the output tone 90C is represented by a two-by-two pixel array, it may be understood to correspond to the third output tone level 80C of FIG. 8, comprising three enabled or printed pixels. When the output tone 90C is selected, an error value is sent to error buffer 93. The error value may be calculated as the difference between the input tone 91 and the density or tone level of output tone 90C.

If the input tone 91 is less than the multi-threshold value THRESH_3, then the input tone 91 is next compared to a multi-threshold value THRESH_2 at operation 96. The multi-threshold value THRESH_2 may be associated with a reduced tone level that is less than output tone 90C. If the input tone 91 is greater than the multi-threshold value THRESH_2, then an output tone 90B is selected. In one embodiment, the output tone 90B comprises a reduced tone level that is less than output tone 90C. Where the output tone 90B is represented by a two-by-two pixel array, it may be understood to correspond to the second output tone level 80B of FIG. 8, comprising two enabled or printed pixels. When the output tone 90B is selected, an error value is sent to error buffer 93. The error value may be calculated as the difference between the input tone 91 and the density or tone level of output tone 90B.

If the input tone 91 is less than the multi-threshold value THRESH_2, then the input tone 91 is next compared to a multi-threshold value THRESH_1 at operation 98. The multi-threshold value THRESH_1 may be associated with a reduced tone level that is less than output tone 90B. If the input tone 91 is greater than the multi-threshold value THRESH_1, then an output tone 90A is selected. In one embodiment, the output tone 90A comprises a reduced tone level that is less than output tone 90B. Where the output tone 90A is represented by a two-by-two pixel array, it may be understood to correspond to the first output tone level 80A of FIG. 8, comprising a single enabled or printed pixel. When the output tone 90A is selected, an error value is sent to error buffer 93. The error value may be calculated as the difference between the input tone 91 and the density or tone level of output tone 90A.

If the input tone 91 is less than the multi-threshold value THRESH_1, then an output tone 95 is selected. In one embodiment, the output tone 95 is associated with a zero tone or paper white. Where the output tone 95 is represented by a two-by-two pixel array, it may be understood to correspond to a pixel region where none of the pixels are enabled or printed. When the output tone 95 is selected, an error value is sent to error buffer 93. In one embodiment, the error value equals the input tone 91.

By including or controlling the predicted dot gain error in the quantization error calculation for a first pixel region, dot gain and error correction of the next pixel region is also controlled. In one embodiment, the multi-thresholding operation 90 sets a very high probability to output the second output tone level 80B (FIG. 8), followed by a reduced probability to output the first output tone level 80A (FIG. 8). A relatively low probability to output the third output tone level 80C (FIG. 8) may be set to discourage selection of the third output tone level 80C. This may simplify control of pixel connection patterns and placement in the pixel region. In one embodiment, the multi-threshold value THRESH_3 is set close to the multi-threshold value THRESH_4.

The halftone operation 90 may comprise additional multi-thresholding values, tone level values and associated error calculations where the output tone level is represented by more pixels. For example, instead of representing a maximum tone level as four pixels, the maximum tone level may be comprised of nine, sixteen, twenty five, or more pixels.

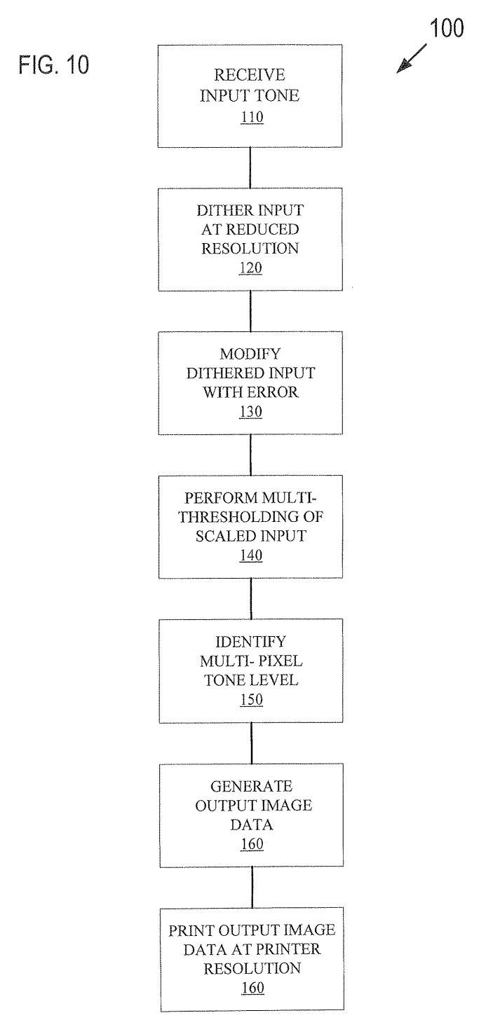

FIG. 10 illustrates an example operation 100 of multi-threshold halftone processing. The operation 100 may be understood to operate with, but not limited by, the devices, apparatus, and systems described with respect to the various embodiments illustrated herein as FIGS. 3-9. At operation 110, an input image data comprising an input tone is received, wherein the input image data is associated with an input resolution.

At operation 120, the input image data is dithered, rendered, or scaled to a halftone resolution. The halftone resolution may be greater than the input resolution. The halftone resolution may be less than a printing resolution. In one embodiment, the halftone resolution is one half the printing resolution of a printing device. In other embodiments, the halftone resolution may be one fourth, one eighth, or some other fraction of the maximum printing resolution.

At operation 130, the scaled image data is modified with a halftone error during an error diffusion process. The error diffusion process may provide gamma correction of the input image data, wherein the gamma correction is achieved without the use of a gamma correction curve.

At operation 140, multi-thresholding of the scaled image data is performed. In one embodiment, the scaled image data is modified with the halftone error prior to performing the multi-thresholding. Certain multi-threshold values may be weighted to preferentially select one or more multi-pixel output tone levels.

At operation 150, the multi-pixel output tone level corresponding with the input tone is identified. The multi-pixel output tone level may be identified as a pixel region comprising an array or matrix of pixels. For example, where the second resolution is one half the maximum printing resolution, the multi-pixel output tone level may be identified by a two-by-two array of pixels. A tone level of the pixel region may be determined according to the number of pixels in the pixel region that are enabled or printed.

At operation 160, output image data comprising the multi-pixel output tone level is generated. The multi-pixel output tone level may be associated with a measured tone density of the printed pixel region. The measured tone density may be used during error diffusion and multi-thresholding to provide gamma correction of the input image data.

At operation 170, the output image data is printed, wherein the output image data is printed at the printing resolution of the printing device. The printing device may be configured to print at a maximum printing resolution.

In one embodiment, an algorithm associated with the halftone operation 90 may be provided as follows:

```
Tone = inColor + getError (current position)
If (Tone > th4)
      output pixel(4)
      error = Tone − 255
else if (Tone > th3)
      output pixel(3)
      error = Tone − dL3
else if (Tone > th2)
      output pixel(2)
      error = Tone − dL2
else if (Tone > 1−pixel)
      output pixel(1)
      error = Tone − dL1
else
      output white
      error = Tone
```

It should be appreciated that any reference to color, color range or color level in this specification is equally applicable to monochromatic images. Similarly, it should be appreciated that any reference to monochrome, greyscale or grey levels in this specification is equally applicable to color images. Any reference to printer, graphic device or printing device may be understood to apply to printer color controller, multifunction printer (MFP) and raster driver, for example. Whereas various embodiments are illustrated using bi-tonal printing examples, it is understood that the embodiment may also include multi-level printing systems, wherein a single pixel may be associated with varying tone levels.

The system and apparatus described above can use dedicated processor systems, micro-controllers, programmable logic devices, or microprocessors that perform some or all of the operations. Some of the operations described above may be implemented in software and other operations may be implemented in hardware. It is further understood that computer-readable medium having instructions stored thereon may be provided, wherein if the instructions are executed by at least one device, they are operable to perform some or all of the operations.

For the sake of convenience, the operations are described as various interconnected functional blocks or diagrams. This is not necessary, however, and there may be cases where these functional blocks or diagrams are equivalently aggregated into a single logic device, program or operation with unclear boundaries.

Having described and illustrated the principles of the invention in a preferred embodiment thereof, it should be apparent that the invention may be modified in arrangement and detail without departing from such principles. We claim all modifications and variation coming within the spirit and scope of the following claims.

1. An image processing system comprising:
a printing device having a printing resolution; and
a processor configured to:
receive input image data comprising an input tone;
dither the input image data at a scaling resolution, wherein the second scaling resolution is less than the printing resolution of the printing device;
perform multi-thresholding of the dithered image data to identify a multi-pixel output tone level;
generate output image data comprising the multi-pixel output tone level; and
print the output image data, wherein the output image data is printed at the printing resolution.

2. The image processing system according to claim 1, wherein the processor is further configured to:
modify the dithered image data with a halftone error value prior to performing the multi-thresholding.

3. The image processing system according to claim 2, wherein the processor is further configured to:
determine a new halftone error for the identified multi-pixel output tone level; and
store the new halftone error to modify a subsequent dithered image data.

4. The image processing system according to claim 1, wherein the multi-pixel output tone level is associated with a measured tone level of a printed output tone.

5. The image processing system according to claim 4, wherein the multi-pixel output tone level comprises an array having a maximum of four printed pixels.

6. The image processing system according to claim 1, wherein the halftone resolution is one half the printing resolution.

7. A method of image reproduction comprising:
receiving input image data comprising an input tone;
scaling the input image data at a halftone resolution, wherein the halftone resolution is one half a printing resolution of a printing device;
performing multi-thresholding of the scaled image data to identify a multi-pixel output tone level corresponding with the input tone;
generating output image data comprising the multi-pixel output tone level; and
printing the output image data, wherein the output image data is printed at the printing resolution of the printing device.

8. The method according to claim 7, wherein the multi-pixel output tone level is associated with a pixel region comprising a plurality of pixels, and wherein the method further comprises:
applying error diffusion to the pixel region as a whole.

9. The method according to claim 8, wherein the pixel region comprises a two-by-two matrix of individual pixels, and wherein the multi-pixel output tone level identifies the number of individual pixels which are printed within the pixel region.

10. The method according to claim 9, further comprising:
printing a test pattern comprising different combinations of printed pixels in the two-by-two matrix; and
measuring an actual print density of each combination.

11. The method according to claim 10, further comprising:
assigning different threshold values for each combination of the two-by-two matrix;
comparing the input image data with one or more of the different threshold values to identify the multi-pixel output tone level; and
performing an error diffusion of the multi-pixel output tone level using the actual print density.

12. The method according to claim 11, wherein the error diffusion dithers the input image data at the halftone resolution and outputs the output image data at the printing resolution.

13. The method according to claim 11, wherein a multi-pixel output tone level associated with three enabled pixels is set close to a multi-pixel output tone level associated with four enabled pixels to discourage a selection of the multi-pixel output tone level associated with three enabled pixels.

14. A computer-readable medium having instructions stored thereon, wherein if the instructions are executed by at least one device, the instructions are operable to:
receive input image data comprising an input tone;
rendering the input image data to a halftone resolution, wherein the halftone resolution is less than a printing resolution;
perform multi-thresholding of the rendered image data to identify a multi-pixel output tone level;
generate output image data comprising the multi-pixel output tone level; and
print the output image data, wherein the output image data is printed at the printing resolution.

15. The computer readable medium according to claim 14, wherein the instructions are further configured to:
apply an error correction to the dithered image data prior to performing the multi-thresholding.

16. The computer readable medium according to claim 15, wherein the error correction is applied to a pixel region comprising a plurality of pixels, and not to each individual pixel.

17. The computer readable medium according to claim 16, wherein the instructions are further configured to:
retrieve a measured tone value associated with the multi-pixel output tone level, wherein the measured tone value is used for the error correction.

18. The computer readable medium according to claim 16, wherein applying the error correction to the pixel region using the measured tone value provides a gamma correction of the input tone.

19. The computer readable medium according to claim 18, wherein the input tone is reproduced without using a gamma correction curve.

20. The computer readable medium according to claim 14, wherein the multi-pixel output tone level identifies a pixel region comprised of a plurality of pixels, and wherein the pixel region is a subset of a printed halftone dot.
